(19) United States
(12) Patent Application Publication
(10) Pub. No.: US 2008/0229528 A1
(43) Pub. Date: Sep. 25, 2008

(54) Floor-cleaning device

(75) Inventors: Chi-Tzo Chen, Taya Hsiang (TW); Pang-Chun Liu, Taya Hsiang (TW); Kun-Yuan Chen, Taya Hsiang (TW)

Correspondence Address: CHARLES E. BAXLEY, ESQUIRE, 90 JOHN STREET, SUITE 309, NEW YORK, NY, 10038, US

(73) Assignee: Gooten Innolife Corporation

(21) Appl. No.: 11/726,886

(22) Filed: Mar. 23, 2007

(51) Int. Cl. B08B 13/00

(52) U.S. Cl. 15/3

(57) ABSTRACT

A floor-cleaning device primarily comprises a pair of driving units provided at two opposite sides of a main body thereof wherein the driving units are electrically connected to a control unit and a power-supply unit which are both deposited in the main body so that the main body is capable of moving freely on a substantial surface. Particularly, a moving-along-edge sensing unit is provided at the left or right side of the main body to conduct a movement of the main body along the edge of the surrounding objects. The sensing unit is composed of non-contact sensing components so as to permit the main body to move along the edge of the surrounding objects with a predetermined distance in a continuous slightly oscillatory S-shaped route. In virtue of the sensing unit, the main body can automatically approach and connect to a charger for automatic charge.

### BACKGROUND OF THE INVENTION

1. Technical Field

The present invention relates to floor-cleaning devices and, more particularly, to a floor-cleaning device capable of moving along the edge of surrounding objects. The present invention further includes the system and the method for the cleaning device to automatically approach and connect to a charger for automatic charge.

2. Description of Related Art

A conventional floor-cleaning device capable of moving along the edge of surrounding objects primarily comprises a main body, two driving units, a control unit installed in the main body for controlling the driving units to propel the main body to move on a substantial surface, and a sensing unit comprising a plurality of sensors deposited at the periphery of the main body and a bumper, whereby when the front edge of the main body touches an external object, the bumper pushes inward to press against the sensors and when the front edge leaves from the external object, the bumper releases the sensors wherein when the sensors are either pressed or released, the sensing unit shall generate a corresponding signal to the control unit.

The foresaid conventional floor-cleaning device is capable of moving along the edge of surrounding objects. That is because during the movement of the main body, when the bumper touches an external object, the sensor located correspondingly is actuated, and the control unit directs the main body to turn away and makes the bumper to depart from the external object. Subsequently, after the main body moves forward for a predetermined distance under the direction of the control unit, it would be directed to turn toward the external object for a predetermined angle and move forward until the bumper touches the external object again and the sensor located correspondingly gets pressed. At this time, the control unit once again drives the main body to turn away from the external object and makes the bumper leave from the external object. When the main body moves in the said route and mode, it appears to move along the edge of the external object.

As the bumper repeatedly touches and departs from the external object during the floor-cleaning device moving in the said route, the discussed floor-cleaning device is identified as implementing an impact (contact) sensing method. Further, the move route, shown as the dotted line in FIG. 1, comprises sections of straight, sections of moving toward the external object and sections of moving away from the external object.

It is believed that the sensing unit is liable to mechanical fatigue when the impact sensing method is used. Consequently, the lifetime of the sensing unit can be significantly shortened. Also, the noise caused by the impact of the bumper against the edge of the external object can constantly occur during operation. Moreover, as the move route shown in FIG. 1, the phenomenon that the cleaning device repeatedly impacts and leaves the external object may give a user an impression that the cleaning device moves unsteadily. Besides, a conventional floor-cleaning device may stay still when the accumulated power is not sufficient, and can not get charged until a user move it to a power supply and put the plug thereof into an electrical outlet. This is substantially an obstacle to the full automation of the floor-cleaning device. Thus, a need exists for a floor-cleaning device performing an improved move mode and equipped with an automatic charging method.

### SUMMARY OF THE INVENTION

The present invention has been accomplished under these circumstances in view. It is one objective of the present invention to provide a cleaning device implementing a non-contact sensing unit to conduct a movement along the edges of surrounding objects. Thereby, when the cleaning device moves along the surrounding objects, it can always separate from the surrounding objects with a predetermined interval instead of touching the edges of the surrounding objects.

It is another objective of the present invention to provide a cleaning device which uses said moving-along-edge mode to seek an exclusive charger and conduct charging automatically when being in a low-power status.

It is still another objective of the present invention to provide a cleaning device, which can move in an involute spiral mode, a U-shape mode, a moving-along-edge mode and an escape mode. The said modes can be conducted according to a pre-programmed order or randomly to permit the floor-cleaning device of an efficient automatic cleaning process.

To achieve these and other objectives of the present invention, the floor-cleaning device primarily comprises a pair of driving units provided at two side of a main body thereof wherein the driving units are electrically connected to a control unit and a power-supply unit which are both deposited in the main body so that the main body is capable of moving freely on a substantial surface. Particularly, a sensing unit is provided on the either side of the main body to conduct a movement of the main body along the edge of surrounding objects. The sensing unit is composed of non-contact sensing components so as to permit the main body to move along the edge of surrounding objects with a predetermined distance in a continuous slightly oscillatory S-shaped route. In virtue of the sensing unit, the main body can automatically approach and connect to a charger for automatic charge.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing a conventional floor-cleaning device moving along the edge of an external object;

FIG. 2 is an oblique top elevation of the floor-cleaning device of the present invention;

FIG. 3 is a top view of the floor-cleaning device of the present invention;

FIG. 4 is a left lateral view of the floor-cleaning device of the present invention;

FIG. 5 is a rear view of the floor-cleaning device of the present invention;

FIG. 6 is an oblique bottom elevation of the floor-cleaning device of the present invention;

FIG. 7 is a schematic drawing showing the disclosed floor-cleaning device of the present invention moving along an edge of an external object;

FIG. 8 is a schematic drawing illustrating the disclosed floor-cleaning device approaching the charger;

FIG. 9 is a schematic drawing illustrating the disclosed floor-cleaning device connecting with the charger;

FIG. 10 is a schematic drawing showing the disclosed floor-cleaning device of the present invention moving in a spiral mode;

FIG. 11 is a schematic drawing showing the disclosed floor-cleaning device of the present invention moving in a U-shape-mode; and

FIG. 12 is a schematic drawing showing the disclosed floor-cleaning device of the present invention moving in a continuously Z-shape mode.

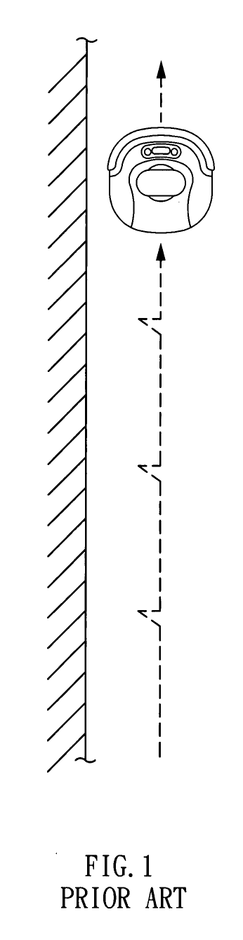

### DETAILED DESCRIPTION OF THE PREFERRED EMBODIMENT

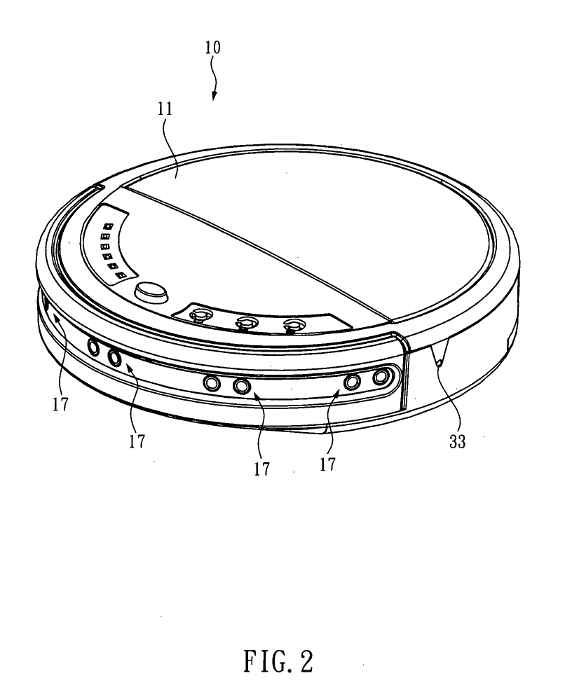

As shown in FIGS. 2 to 6, the disclosed floor-cleaning device 10 apparently comprises a main body 11, a pair of driving units 12 provided at the opposite sides of the main body 11 respectively, a moving-along-edge sensing unit 13 arranged at the left or right side of the main body 11, and a cleaning unit 14 deposited at the bottom of the main body 11. Further, the main body 11 comprises a control unit 15 and a power-supply unit 16 settled therein for being electrically connected with the foresaid units so that the driving units 12 can propel the main body 11 to move on a substantial surface and the move direction of the main body 11 can be changed by adjusting the rotation speed ratio between two driving units 12 while the cleaning unit 1 conducts cleaning over the move route of the main body 11.

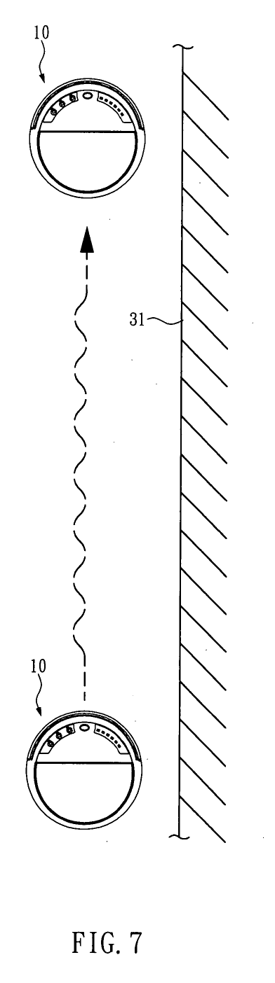

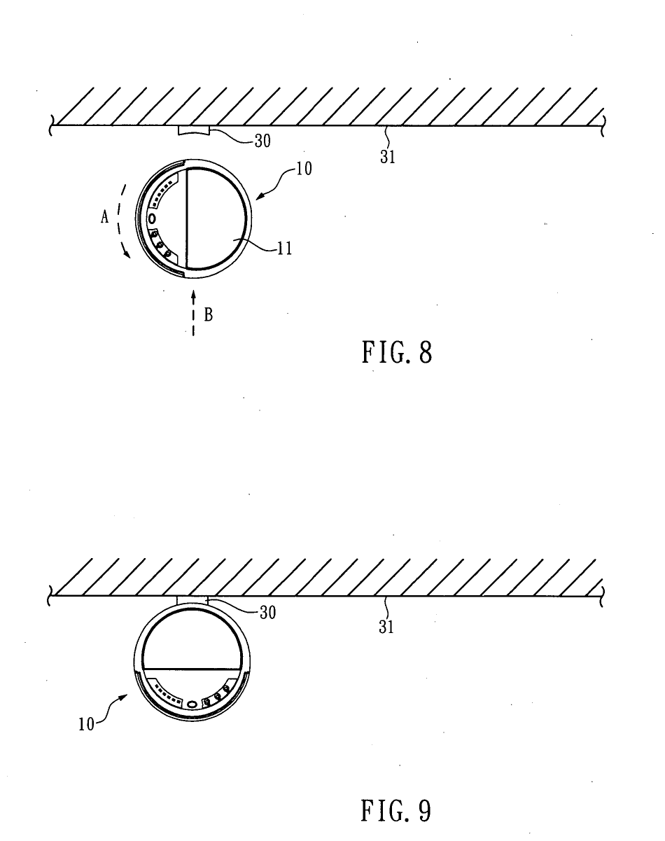

The moving-along-edge sensing unit 13 cooperates with the control unit 15 and the driving units 12 to allow the main body 11 to move along a wall or a barrier (hereinafter referred to as “the edge of the external object 31”), as shown in FIG. 7. The moving-along-edge sensing unit 13 is composed of non-contact sensing components, such as infrared sensing units or ultrasonic sensing units.

In the present embodiment, infrared sensing units are taken for illustration. As shown in FIG. 4, the infrared sensing unit includes a first infrared sensing unit 21 and a second infrared sensing unit 22, which are settled abreast at the left or right side of the main body 11. Each of said first infrared sensing unit 21 and second infrared sensing unit 22 has an infrared emitter and an infrared receiver respectively. During the move route of the main body 11, if the first infrared sensing unit 21 detects the edge of the external object 31 (e.g. a wall), the control unit 15 drives the driving units 12 to propel the main body 11 to move toward the edge of the external object 31. When the first infrared sensing unit 21 and the second sensing unit 22 both detect the edge of the external object 31 at the same time, the control unit 15 directs the driving units 12 to propel the main body 11 to move slightly away from the edge of the external object 31 until the second sensing element 22 no more detects the edge of the external object 31. Then the control unit 15 drives the driving units 12 to propel the main body 11 to move toward the edge of the external object 31 again until the first infrared sensing unit 21 and the second sensing unit 22 both detect the edge of the external object 31 once more. Then the main body 11 is driven to move slightly away from the edge of the external object 31. When leaving and approaching the edge of the external object 31 repeatedly, the main body 11 appears as moving along an approximately S-shaped route without contacting the edge of the external object 31.

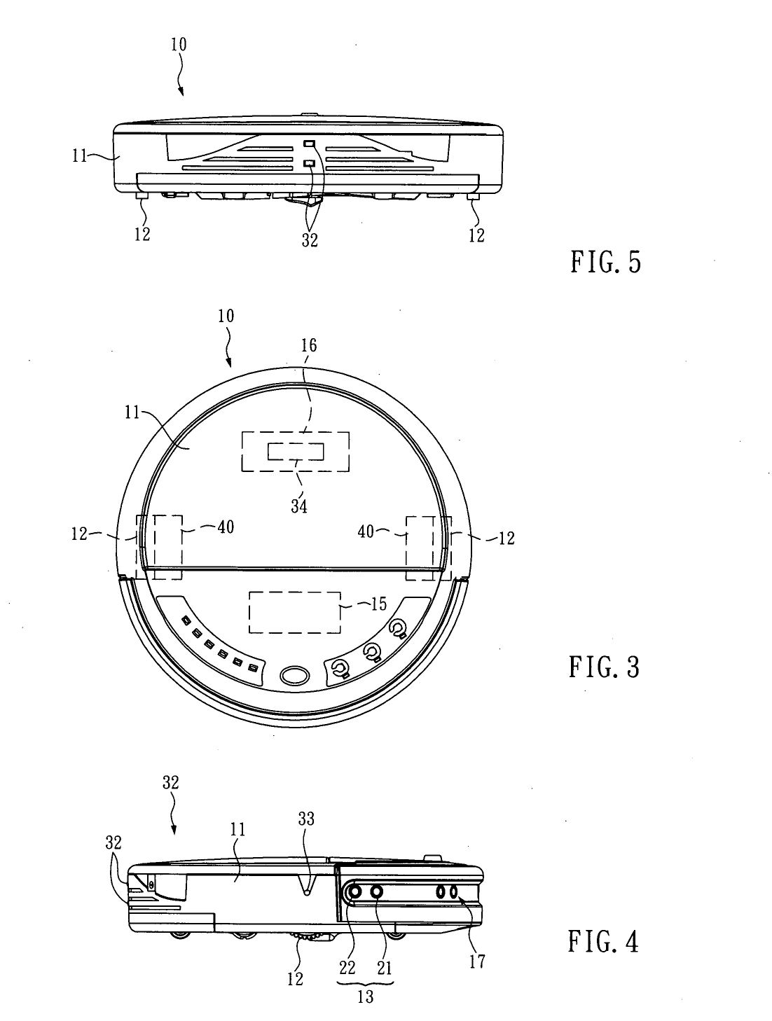

By using the above moving-along-edge mode, the present invention can further perform an automatic charging scheme whereby the floor-cleaning device 10 can seek an exclusive charger and conduct charging automatically. Referring to FIGS. 3, 5, 7 and 9, the present invention further comprises following components.

A charger 30, which is deposited at a predetermined location at the edge of an external object 31 and is connected with a power source, can-emit a location signal.

A power-receiving unit 32, which is settled at the surface of the main body 11, can charge the power-supply unit 16 inside the main body 11 when being conductively connected with the charger 30.

A signal-receiving unit 33, which is provided on the main body 11 and is electrically connected with the control unit 15, functions for receiving the location signal emitted by the charger 30.

And, a power-level detecting unit 34, which is provided on the main body 11 and is electrically connected with the control unit 15 as well as the power-supply unit 16, functions for detecting the power level of the power-supply unit 16. When the remaining power level decreases to a predetermined low-power default (about 20% of power remained), the power-level detecting unit 34 emits a low-power signal to the control unit 15 so that the control unit 15 starts the moving-along-edge sensing unit 13 accordingly to propel the main body 11 moving along the edge of the external object 31 in accordance with the foresaid move mode. When the signal-receiving unit 33 detects the location signal of the charger 30, the control unit 15 controls the left and right driving units 12 to make the main body 11 rotate along a direction indicated as arrow A, and then back toward the charger 30 (as depicted by arrow B) so that the power-receiving unit 32 and the charger 30 can be coupled for charging the cleaning device 10.

The location signal emitted by the charger 30 and the signal-receiving unit 33 of the main body 11 may be achieved by ultrasonic or infrared technique.

The control unit 15 of the disclosed subject matter can be pre-programmed with various route programs. The route programs may include random route program, spiral route program, U-shaped route program and more than one escape route programs.

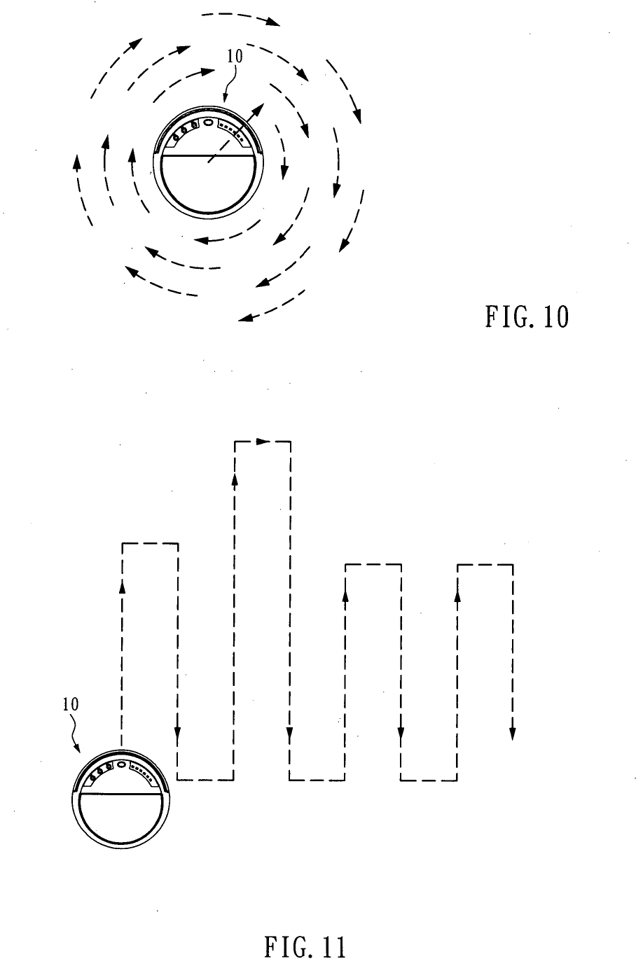

The spiral route program, as shown in FIG. 10, is accomplished by implementing the control unit 15 to control the rotation speed ratio between the left and right driving units 12 so that the main body 11 can move gradually outward along a spiral route. Such a spiral route is applicable to large-scale space without barriers.

The U-shaped route program, as shown in FIG. 11, is accomplished by implementing the control unit 15 to control the main body 11 to make a quarter turn or advance straightly for forming a U-shaped move route. A continuous U-shaped move route is shown in the drawing and is applicable to space with various barriers.

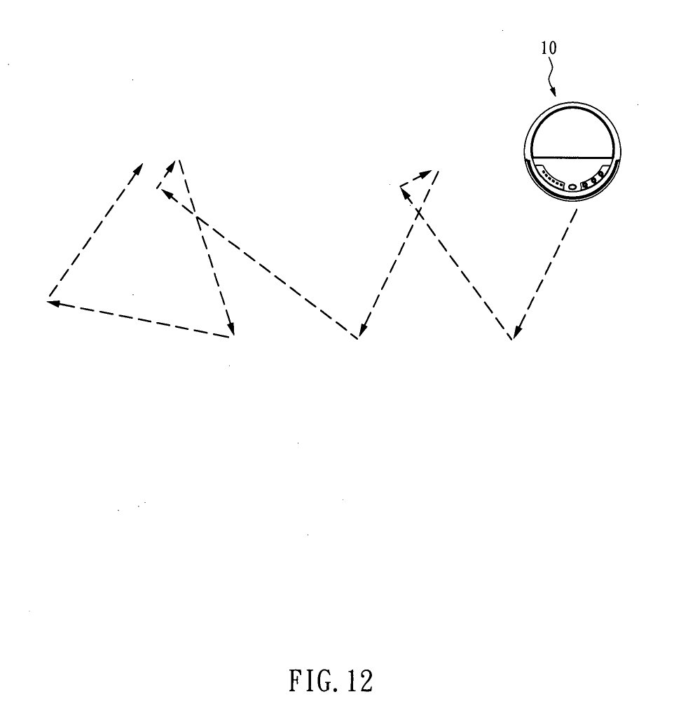

The said U-shaped route program may be further evolved into a Z-shape move mode as shown in FIG. 12. The control unit 15 controls the driving units to propel the main body b to conduct turns with predetermined angles and straight progress whereby a Z-shaped move route can be formed.

The control unit 15 of the main body 11 is capable of integrating the above move modes and allowing the main body 11 to perform the above move modes with a specific order or randomly so that the floor-cleaning device 10 can conduct an automatic cleaning process efficiently.

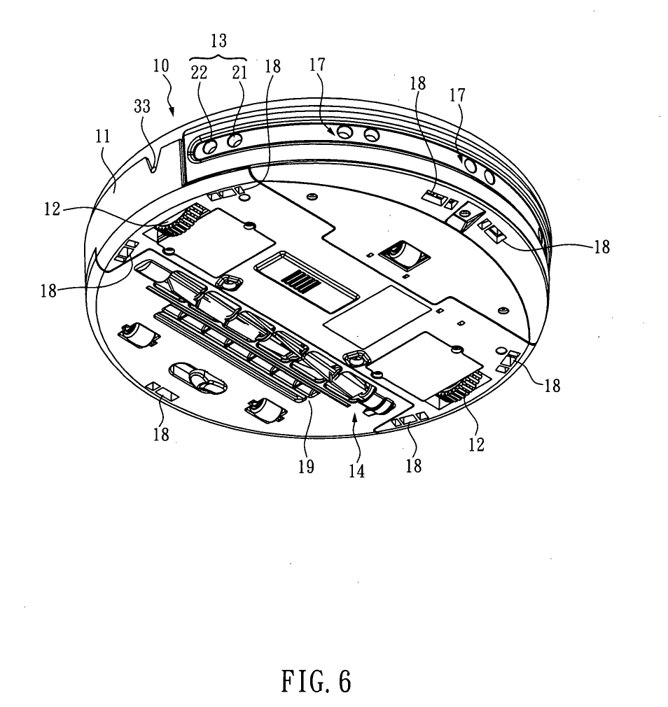

In FIG. 6, a plurality of anti-drop sensing units 18 is provided around the bottom of the main body 11. When one of the anti-drop sensing units 18 detects no substantial surface, the control unit 15 controls the driving unit 12 to remove the main body 11 from that place for avoiding dropping from the substantial surface where it stands. In the present embodiment, the anti-drop sensing units 18 are composed of infrared sensing units.

Also referring to FIG. 6, a plurality of barrier-sensing units 17 is provided at the front portion of the main body 11. When the barrier-sensing units 17 detect a barrier that hinders the main body 11 from progressing, the control unit 15 shall control the driving unit 12 to remove the main body 11 from that place for dodging the barrier. In the present embodiment, the barrier-sensing units 17 are composed of ultrasonic sensing units or infrared sensing units.

Again referring to FIG. 6, an ultraviolet sterilizing device 19 is provided at the bottom of the main body 11. The main body 11 further comprises a safety switch (not shown in the figure) therein connected with the ultraviolet sterilizing device 19. The control unit 15 is also electrically connected with the safety switch. The ultraviolet sterilizing device 19 conducts disinfection and sterilization over the move route of the main body 11. As the control unit 15 recognizes that no substantial surface is detected by all the anti-drop sensing units 18, it represents that the main body 11 has been taken away from the substantial surface and the safety switch shall cut the power of the ultraviolet sterilizing device 19.

Referring back to FIG. 3, each of the left and right driving units 12 of the main body 11 has a photogate assembly 40 respectively. The photogate assembly 40 is electrically connected with the control unit 15 so that the control unit 15 can control the left and right driving units 12 according to the feedback signal of the photogate assembly 40 to direct the rotation angle of the main body 11. Such technique permits the main body 11 of being positioned more accurately during automatic charging.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A floor-cleaning device, comprising:
a main body;
a pair of driving units deposited at the left and right sides of the main body for propelling the main body to move on a substantial surface;
a moving-along-edge sensing unit deposited at the left or right side of the main body that is composed of non-contact sensing components whereby the main body can move along the edge of an external object with a predetermined distance and along a slightly S-shaped route;
a cleaning unit settled at the bottom of the main body; and
a control unit and a power-supply unit, which are settled inside the main body and electrically connected with the,above units in the manner that the driving units can propel the main body to move and the cleaning unit can conduct cleaning during the movement of the main body.

2. The floor-cleaning device of claim 1, wherein the moving-along-edge sensing unit is an infrared sensing unit.

3. The floor-cleaning device of claim 2, wherein the infrared sensing unit comprises a first infrared sensing unit and a second infrared sensing unit, which are arranged abreast at one side of the main body, wherein each of the infrared sensing element includes an infrared emitter and an infrared receiver.

4. The floor-cleaning device of claim 3, wherein during the move route of the main body, when the first infrared sensing unit detects the edge of the external object, the control unit drives the driving units to propel the main body to move toward the edge of the external object; when the first infrared sensing unit and the second sensing unit both detect the edge of the external object at the same time, the control unit drives the driving units to propel the main body to move slightly away from the edge of the external object.

5. The floor-cleaning device of claim 1, wherein the moving-along-edge sensing unit is an ultrasonic sensing unit.

6. The floor-cleaning device of claim 1, further comprising:
a charger, which is deposited at a predetermined location at the edge of an external object and is connected with a power source, for emitting a location signal;
a power-receiving unit, which is settled at the surface of the main body, for connecting with the charger to charge the power-supply unit inside the main body;
a signal-receiving unit, which is provided on the main body and is electrically connected with the control unit, for receiving the location signal emitted by the charger; and
a power-level detecting unit, which is provided on the main body and is electrically connected with the control unit as well as the power-supply unit, for detecting the power level of the power-supply unit wherein when the remaining power level decreases to a predetermined low-power default, the power-level detecting unit emits a low-power signal to the control unit so that the control unit starts the moving-along-edge sensing unit accordingly to propel the main body to move along the edge of the external object until the signal-receiving unit detects the location signal of the charger, and the control unit controls the left and right driving units to make the main body rotate so that the power-receiving unit and the charger can be coupled for charging the cleaning device.

7. The floor-cleaning device of claim 6, wherein the location signal emitted by the charger and the signal-receiving unit of the main body are composed of non-contact sensing components.

8. The floor-cleaning device of claim 7, wherein the non-contact sensing components are infrared sensing components.

9. The floor-cleaning device of claim 7, wherein the non-contact sensing components are ultrasonic sensing components.

10. The floor-cleaning device of claim 1, wherein the control unit is pre-programmed with a random route program, a spiral route program, a U-shaped route program and more than one escape route programs.

11. The floor-cleaning device of claim 1, wherein a plurality of anti-drop sensing units is provided around the bottom of the main body wherein when one of the anti-drop sensing units detects no substantial surface, the control unit controls the driving unit to remove the main body from that place for avoiding dropping from the substantial surface where it stands.

12. The floor-cleaning device of claim 11, wherein the anti-drop sensing units are infrared sensing units.

13. The floor-cleaning device of claim 1, wherein a plurality of barrier-sensing units is provided at the front portion of the main body wherein when the barrier-sensing units detect a barrier that hinders the main body from progressing, the control unit controls the driving unit to remove the main body from that place for dodging the barrier.

14. The floor-cleaning device of claim 13, wherein the barrier-sensing units are ultrasonic sensing units.

15. The floor-cleaning device of claim 13, wherein the barrier-sensing units are infrared sensing units.

16. The floor-cleaning device of claim 1, wherein an ultraviolet sterilizing device is provided at the bottom of the main body wherein the main body further comprises a safety switch therein connected with the ultraviolet sterilizing device and the control unit is also electrically connected with the safety switch.

17. The floor-cleaning device of claim 1, wherein each of the left and right driving units of the main body has a photogate assembly which is electrically connected with the control unit so that the control unit can control the left and right driving units by resorting to the feedback signal of the photogate assembly to direct the rotation angle of the main body.

18. A floor-cleaning device, comprising:
a main body;
a pair of driving units positioned at the left and right sides of the main body for propelling the main body to move on a substantial surface;
a moving-along-edge sensing unit deposited at the left or right side of the main body that is composed of non-contact sensing components whereby the main body can move along the edge of an external object with a predetermined distance and along a slightly S-shaped route;
a cleaning unit settled at the bottom of the main body;
a control unit and a power-supply unit, which are settled inside the main body and electrically connected with the above units in the manner that the driving units can propel the main body to move and the cleaning unit can conduct cleaning during the movement of the main body;
a charger, which is deposited at a predetermined location at the edge of an external object and is connected with a power source, for emitting a location signal;
a power-receiving unit, which is settled at the surface of the main body, for connecting with the charger to charge the power-supply unit inside the main body;
a signal-receiving unit, which is provided on the main body and is electrically connected with the control unit, for receiving the location signal emitted by the charger; and
a power-level detecting unit, which is provided on the main body and is electrically connected with the control unit as well as the power-supply unit, for detecting the power level of the power-supply unit wherein when the remaining power level decreases to a predetermined low-power default, the power-level detecting unit emits a low-power signal to the control unit so that the control unit starts the moving-along-edge sensing unit accordingly to propel the main body moving along the edge of the external object until the signal-receiving unit detects the location signal of the charger, and the control unit controls the left and right driving units to make the main body rotate so that the power-receiving unit and the charger can be coupled for charging the cleaning device.

19. The floor-cleaning device of claim 18, wherein the moving-along-edge sensing unit is an infrared sensing unit.

20. The floor-cleaning device of claim 19, wherein the infrared sensing unit comprises a first infrared sensing unit and a second infrared sensing unit, which are arranged abreast at one side of the main body, wherein each of the infrared sensing unit includes an infrared emitter and an infrared receiver.
